(19) United States
(12) Patent Application Publication
(10) Pub. No.: US 2023/0388459 A1
(43) Pub. Date: Nov. 30, 2023

(54) DISPLAY METHOD AND DISPLAY SYSTEM

(71) Applicant: SEIKO EPSON CORPORATION, Tokyo (JP)

(72) Inventors: Hiroki NISHIOKA, Suwa-shi (JP); Kunio YONENO, Shiojiri-shi (JP)

(21) Appl. No.: 18/322,653

(22) Filed: May 24, 2023

(30) Foreign Application Priority Data
May 24, 2022 (JP) 2022-084425

(51) Int. Cl. H04N 9/31; G01P 3/64

(52) U.S. Cl. CPC H04N 9/31; G01P 3/64

(57) ABSTRACT

A display method includes acquiring output corresponding to a movement speed of a human from a first position to a second position using at least one sensor, determining an image according to a content used for alert based on the output corresponding to the movement speed, determining timing of display of the image based on the output corresponding to the movement speed, and displaying the image with the timing in a third position using a display apparatus, wherein the second position is located between the first position and the third position.

The present application is based on, and claims priority from JP Application Serial Number 2022-084425, filed May 24, 2022, the disclosure of which is hereby incorporated by reference herein in its entirety.

### BACKGROUND

### 1. Technical Field

The present disclosure relates to a display method and a display system.

### 2. Related Art

In related art, driving of a projector may be controlled based on output of a sensor detecting a motion of a human. For example, JP-A-2016-222408 discloses an alert system including a distance measuring device, a waiting position indication device, and a projection device.

In the system disclosed in JP-A-2016-222408, the distance measuring device measures a distance between an elevator user and an elevator door, the waiting position indication device indicates a waiting position in an elevator hall to the elevator user based on the measured distance of the distance measuring device, and the projection device projects an image showing the waiting position onto a floor surface of the elevator hall based on the indication by the waiting position indication device.

In the system disclosed in JP-A-2016-222408, the movement speed of a human approaching the display position of the image is not considered, and it may be difficult to display an image with appropriate timing or content to the human.

### SUMMARY

A display method according to an aspect of the present disclosure includes acquiring output corresponding to a movement speed of a human from a first position to a second position using at least one sensor, determining an image according to a content used for alert based on the output corresponding to the movement speed, determining timing for display of the image based on the output corresponding to the movement speed, and displaying the image with the timing in a third position using a display apparatus, wherein the second position is located between the first position and the third position.

A display system according to an aspect of the present disclosure includes a display apparatus, a sensor, and a control apparatus controlling operation of the display apparatus, wherein the control apparatus executes acquiring output corresponding to a movement speed of a human from a first position to a second position from the sensor, determining an image according to a content used for alert based on the output corresponding to the movement speed, determining timing for display of the image based on the output corresponding to the movement speed, and displaying the image with the timing in a third position using the display apparatus, and the second position is located between the first position and the third position.

### BRIEF DESCRIPTION OF THE DRAWINGS

FIG. 1 is a schematic diagram of a display system according to a first embodiment.

FIG. 2 is a block diagram showing the display system according to the first embodiment.

FIG. 3 is a flowchart of a display method according to the first embodiment.

FIG. 4 is a flowchart of determination of a content in the display method according to the first embodiment.

FIG. 5 is a diagram for explanation of contents used for display.

FIG. 6 is a flowchart of display of a content in the display method according to the first embodiment.

FIG. 7 is a diagram for explanation of an example of display timing by the display method according to the first embodiment.

FIG. 8 is a flowchart of display of a content in a display method according to a second embodiment.

FIG. 9 is a diagram for explanation of an example of display timing by the display method according to the second embodiment.

FIG. 10 is a diagram for explanation of another example of display timing by the display method according to the second embodiment.

FIG. 11 is a schematic diagram of a display system according to a third embodiment.

FIG. 12 is a flowchart of determination of a content in a display method according to a fourth embodiment.

### DESCRIPTION OF EXEMPLARY EMBODIMENTS

As below, preferred embodiments of the present disclosure will be explained with reference to the accompanying drawings. In the drawings, the dimensions and scales of the respective parts are appropriately different from real ones and some parts are schematically shown to facilitate understanding. Further, the scope of the present disclosure is not limited to these embodiments unless there is particular description limiting the present disclosure.

### 1. First Embodiment

### 1-1. Outline of Display System

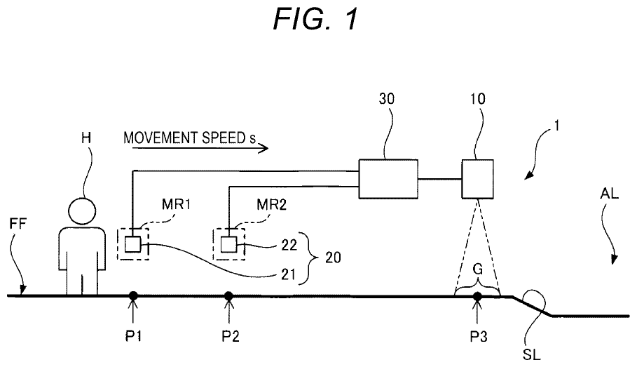

FIG. 1 is a schematic diagram of a display system 1 according to a first embodiment. The display system 1 is a system displaying an image G in a third position P3 using a display apparatus 10. More specifically, the display system 1 determines a content and display timing of the image G based on a movement speed s of a human H sequentially passing through a first position P1 and a second position P2 and approaching the third position P3, and displays the image G showing the determined content with the determined display timing in the third position P3. Note that timing used in the following description refers to “time”.

In the example shown in FIG. 1, the display system 1 alerts the human H coming down an aisle AL using the image G. Here, a slope SL is provided on a floor FF in the middle in the length direction of the aisle AL. The respective first position P1, second position P2, and third position P3 are positions in the length direction of the aisle AL and located on the left in FIG. 1 with respect to the slope SL. Further, the first position P1, the second position P2, and the third position P3 are sequentially arranged in a direction toward the slope SL. The third position P3 is a display position of the display apparatus 10 and set on the floor surface FF of the aisle AL in a position adjacent to the slope SL in the length direction of the aisle AL. The display position is e.g., the center of the image G.

Note that the form of the aisle AL including a width or a shape is not limited to the example shown in FIG. 1, but may be arbitrary. Further, the third position P3 is not limited to the example shown in FIG. 1, but may be, e.g., a position apart from the slope SL, a position on a screen provided in the aisle AL, or a position on a left or right wall surface or a ceiling surface of the aisle AL.

The display system 1 includes the display apparatus 10, a sensor 20, and a control apparatus 30. As below, these will be briefly explained with reference to FIG. 1.

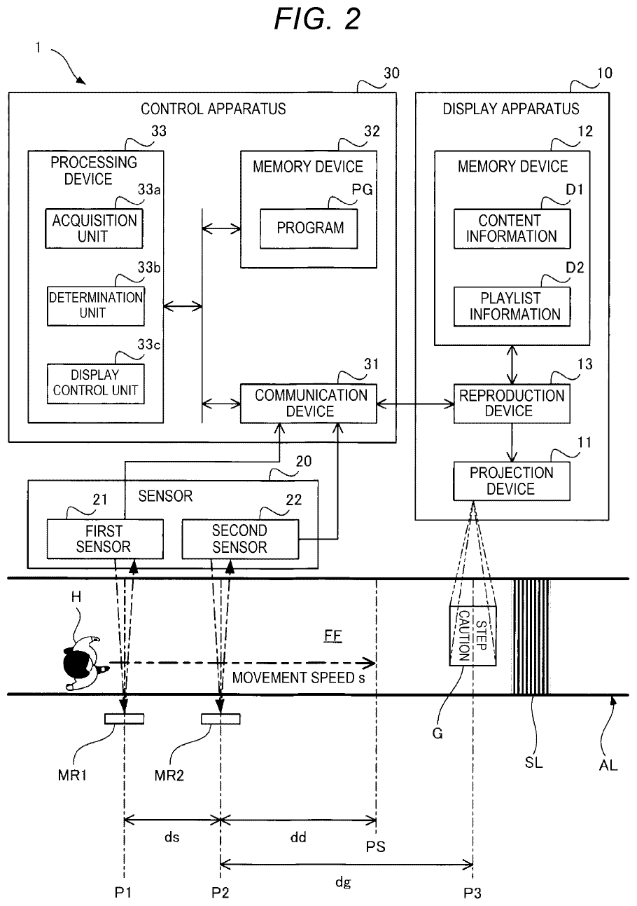

The display apparatus 10 is a projector displaying the image G in the third position P3 under control of the control apparatus 30. The detailed configuration of the display apparatus 10 will be explained later with reference to FIG. 2.

The sensor 20 is a sensor outputting in response to the movement speed s of the human H from the first position P1 to the second position P2. In the example shown in FIG. 1, the sensor 20 includes a first sensor 21 detecting passing of the human H through the first position P1 and a second sensor 22 detecting passing of the human H through the second position P2.

The respective first sensor 21 and second sensor 22 are sensors such as photoelectronic sensors and attached to one wall of the pair of left and right walls of the aisle AL. Though not shown in the drawing, the respective first sensor 21 and second sensor 22 have light emitting elements including LEDs (light-emitting diodes) or laser diodes and light receiving elements including phototransistors or photodiodes. The light emitted by the light emitting element may be visible light or infrared light. Further, the respective first sensor 21 and second sensor 22 may have circuits for amplification sensitivity adjustment or output polarity setting in addition to the light emitting elements and the light receiving elements.

In the example shown in FIG. 1, a reflector MR1 is provided to face the first sensor 21 and a reflector MR2 is provided to face the second sensor 22 on the other wall of the pair of walls. The respective reflectors MR1, MR2 are structures having light reflectivity such as corner cube arrays. The reflector MR1 reflects the light from the light emitting element of the first sensor 21 toward the light receiving element of the first sensor 21. Similarly, the reflector MR2 reflects the light from the light emitting element of the second sensor 22 toward the light receiving element of the second sensor 22.

In the above described sensor 20, when no object is present in the first position P1, the light from the light emitting element of the first sensor 21 is reflected by the reflector MR1 and received by the light receiving element of the first sensor 21. On the other hand, when an object is present in the first position P1, the light from the light emitting element of the first sensor 21 is shielded by the object and not received by the light receiving element of the first sensor 21. For example, when no object is present in the first position P1, the first sensor 21 outputs a high-level signal and, when an object is present in the first position P1, outputs a low-level signal. The low-level signal output when an object is present in the first position P1 corresponds to a first signal. Similarly, for example, when no object is present in the second position P2, the second sensor 22 outputs a high-level signal and, when an object is present in the second position P2, outputs a low-level signal. The low-level signal output when an object is present in the second position P2 corresponds to a second signal.

As described above, in the sensor 20, when the human H moves from the first position P1 to the second position P2, the output of the first sensor 21 changes with the timing of the human H passing through the first position P1, and then, the output of the second sensor 22 changes with the timing of the human H passing through the second position P2. Therefore, the output of the sensor 20 changes in response to the movement speed s of the human H from the first position P1 to the second position P2. Further, the movement direction of the human H may be determined based on the order of detection by the first sensor 21 and the second sensor 22.

Note that the respective reflectors MR1, MR2 are provided as necessary or may be omitted. In this case, for example, the other wall functions as the reflectors MR1, MR2. There is an advantage that detection accuracy of the sensor 20 is easily increased when the structures having light reflectivity such as corner cube arrays are used as the reflectors MR1, MR2.

The control apparatus 30 is an apparatus controlling operation of the display apparatus 10 based on the output of the sensor 20. Here, the control apparatus 30 acquires the output corresponding to the movement speed s of the human H from the first position P1 to the second position P2 using the sensor 20. Further, the control apparatus 30 determines a content used for alert and timing of display of the content as the image G based on the output corresponding to the movement speed s. Furthermore, the control apparatus 30 displays the content as the image G with the timing in the third position P3 using the display apparatus 10. The detailed configuration of the control apparatus 30 will be explained later with reference to FIG. 2.

In the display system 1 having the above described configuration, the respective content and display timing of the image G used for alert are determined in response to the movement speed s of the human H toward the third position P3. Accordingly, the image G may be displayed with the appropriate timing or content to the human H.

### 1-2. Configuration of Display System

FIG. 2 is a block diagram showing the display system 1 according to the first embodiment. In FIG. 2, not only the electrical configuration of the display system 1 but also a view of the aisle AL as seen from vertically above are shown. As described above, the display system 1 includes the display apparatus 10, the sensor 20, and the control apparatus 30. As below, the display apparatus 10 and the control apparatus 30 will be described in detail with reference to FIG. 2.

As shown in FIG. 2, the display apparatus 10 includes a projection device 11, a memory device 12, and a reproduction device 13.

The projection device 11 is a mechanism projecting the image G in the third position P3. Though not shown in the drawing, the projection device 11 has e.g., an image processing circuit, a light source, a light modulator, and a projection system.

The image processing circuit of the projection device 11 is a circuit generating an image signal for driving the light modulator using image information within content information D1 from the reproduction device 13. Specifically, the image processing circuit has a frame memory, and generates the image signal by loading the image information within the content information D1 in the frame memory and appropriately executing various kinds of processing including resolution conversion processing, resize processing, and distortion correction processing.

The light source of the projection device 11 includes e.g., a halogen lamp, a xenon lamp, a super high-pressure mercury lamp, an LED (Light Emitting Diode), or a laser beam source. For example, the light source outputs a white light or respectively outputs red, green, and blue lights. When the light source outputs a white light, the light output from the light source has a luminance distribution with reduced variations by an optical integration system (not shown), and the light is separated into red, green, and blue lights by a color separation system (not shown) and enter the light modulator of the projection device 11.

The light modulator of the projection device 11 includes three light modulation elements provided to correspond to the above described red, green, and blue. The respective three light modulation elements include e.g., transmissive liquid crystal panels, reflective liquid crystal panels, or DMDs (digital mirror devices). The three light modulation elements respectively modulate the red, green, and blue lights based on the image signal from the image processing circuit of the projection device 11 and generate image lights of the respective colors. The image lights of the respective colors are combined by a light combining system (not shown) into a full-color image light.

The projection system of the projection device 11 focuses and projects the above described full-color image light on a projection surface. The projection system is e.g., an optical system including a projection lens. The projection system may include e.g., a zoom lens or a focus lens in addition to the projection lens.

The memory device 12 is a device storing the content information D1 and playlist information D2. The memory device 12 includes e.g., a hard disk drive or a semiconductor memory. Note that part or all of the information stored in the memory device 12 may be stored in advance or acquired from an external device coupled to the memory device 12 via wireless or wired connection. Further, the memory device 12 may be a portable memory card or memory disk.

The content information D1 is image information on the content of the image G. The content information D1 contains image information on a plurality of types of contents used for the image G. The image information on the plurality of types of contents is e.g., image information on display for alert to the human H. Here, the image information may be still image information or moving image information. Further, information such as sound information for alert may be added to the image information. The content information D1 may contain image information representing a black image for a view not displaying the image G in addition to the information representing the image for alert to the human H. Specific examples of the content information D1 will be explained later with reference to FIG. 5.

The playlist information D2 is information on a playlist in which one or more reproduction objects, a reproduction order, reproduction time lengths, etc. of the image information contained in the content information D1 are described. The playlist information D2 contains information on one or more different playlists of the reproduction objects, the reproduction order, and the reproduction time lengths. Note that the playlist information D2 is used as necessary or may be omitted. In this case, the control apparatus 30 may execute processing of determining the reproduction object, the reproduction order, the reproduction time length, etc. of the information within the content information D1 and control driving of the reproduction device 13 based on the determination result. There is an advantage that drive control of the reproduction device 13 by the control apparatus 30 is simplified using the playlist information D2.

The reproduction device 13 is a device reading and transmitting information stored in the memory device 12 to the projection device 11 under control of the control apparatus 30. Specifically, the reproduction device 13 appropriately transmits the information within the content information D1 to the projection device 11 based on the playlist information D2 under control of the control apparatus 30. The reproduction device 13 is e.g., a device such as a memory card reader, a personal computer, or a DVD (Digital Versatile Disk) player. Note that the reproduction device 13 may be integrally formed with the projection device 11 or formed as a part of the control apparatus 30. When the reproduction device 13 is formed as a part of the control apparatus 30, also, the above described memory device 12 may be formed as a part of the control apparatus 30.

As shown in FIG. 2, the control apparatus 30 includes a communication device 31, a memory device 32, and a processing device 33. These are communicably coupled to one another via a common bus.

The communication device 31 is a device that can communicate with the respective display apparatus 10 and sensor 20 via wired or wireless connection. Specifically, the communication device 31 has an interface circuit for communication with the display apparatus 10 and an interface circuit for communication with the sensor 20. For example, the communication device 31 includes a wired communication device such as a wired LAN (Local Area Network), a USB (Universal Serial Bus), and an HDMI (Hight Definition Multimedia Interface) and a wireless communication device such as a wireless LAN including LPWA (Low Power Wide Area) and WiFi or Bluetooth. “HDMI”, “WiFi”, and “Bluetooth” are respectively registered trademarks.

The memory device 32 is a device storing a program PG executed by the processing device 33 and various kinds of information processed by the processing device 33. The memory device 32 includes e.g., a hard disk drive or a semiconductor memory. Note that part or all of the information stored in the memory device 32 may be stored in advance or acquired from an external device via the above described communication device 31.

The processing device 33 is a processing device having a function of controlling operation of the respective units of the control apparatus 30 and a function of processing various kinds of data. For example, the processing device 33 includes e.g., one or more processors such as CPUs (Central Processing Units). Note that part or all of the processing device 33 may be realized by hardware such as a DSP (Digital Signal Processor), an ASIC (Application Specific Integrated Circuit), a PLD (Programmable Logic Device), or an FPGA (Field Programmable Gate Array).

The processing device 33 executes the program PG, and thereby, functions as an acquisition unit 33a, a determination unit 33b, and a display control unit 33c.

The acquisition unit 33a acquires output corresponding to the movement speed s of the human H from the first position P1 to the second position P2 using the sensor 20. More specifically, the acquisition unit 33a acquires the low-level output of the first sensor 21 and the second sensor 22 and calculates a time difference is between a first time t1 when the low-level output of the first sensor 21 is acquired and a second time t2 when the low-level output of the second sensor 22 is acquired. Here, the acquisition unit 33a stores respective information of the first time t1, the second time t2, and the time difference ts in the memory device 32. Hereinafter, the acquisition of the low-level output of the first sensor 21 and the second sensor 22 is referred to as acquisition of the output of the first sensor 21 and the second sensor 22.

Here, the first time t1 is a time when the human H passes through the first position P1. The second time t2 is a time when the human H passes through the second position P2. The time difference ts is a time length when the human H moves from the first position P1 to the second position P2. A distance ds between the first position P1 and the second position P2 is fixed and the time difference ts changes in response to the movement speed s of the human H from the first position P1 to the second position P2. The movement speed s is calculated using a relationship s=ds/(t2−t1).

The determination unit 33b determines the content used for alert and the timing of display of the content as the image G based on the output from the sensor 20. More specifically, the determination unit 33b determines the content and the timing in response to the time difference ts based on the output from the sensor 20. Note that, in view of prevention of unnecessary display, even when the output from the sensor 20 is acquired, the determination unit 33b determines that the content is not displayed as the image G if the second time t2 is before the first time t1.

Here, the timing includes start timing and end timing of display of the image G. The start timing is set to be timing of the human H located in a position PS between the second position P2 and the third position P3. That is, a distance dd between the second position P2 and the position PS is shorter than a distance dg between the second position P2 and the third position P3. The difference between the distance dd and the distance dg is not particularly limited, but e.g., from 1 m to 3 m. Note that the position PS and the distance dd may be fixed or changed in response to the movement speed s of the human H from the first position P1 to the second position P2. The end timing is not particularly limited, but set to e.g., timing of the human H passing through the third position P3. When the display time is fixed or the playlist information D2 is used, substantially, only the start timing of display may be set.

The display control unit 33c displays the content determined by the determination unit 33b as the image G with the timing determined by the determination unit 33b in the third position P3 using the display apparatus 10. Specifically, the display control unit 33c designates a playlist within the playlist information D2 for the reproduction device 13 based on the determination result by the determination unit 33b, and thereby, controls the display apparatus 10 to display the desired content as the image G with the desired timing.

### 1-3. Display Method

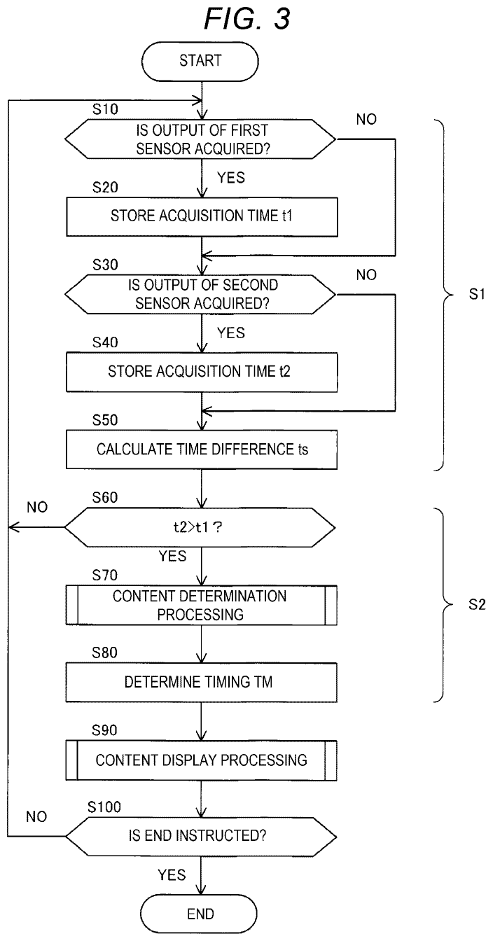

FIG. 3 is a flowchart of a display method according to the first embodiment. The display method is performed using the above described display system 1. In the display system 1, first, as shown in FIG. 3, at step S1, the acquisition unit 33a acquires the output corresponding to the movement speed s of the human H from the first position P1 to the second position P2 using the sensor 20. Step S1 includes step S10 to step S50.

At step S10, whether the acquisition unit 33a acquires the output of the first sensor 21 is determined. When the acquisition unit 33a acquires the output of the first sensor 21 (step S10: YES), at step S20, the acquisition unit 33a stores the acquired first time t1 in the memory device 32.

After step S20 or when the acquisition unit 33a does not acquire the output of the first sensor 21 (step S10: NO), at step S30, whether the acquisition unit 33a acquires the output of the second sensor 22 is determined. When the acquisition unit 33a acquires the output of the second sensor 22, at step S40, the acquisition unit 33a stores the acquired second time t2 in the memory device 32.

After step S40 or when the acquisition unit 33a does not acquire the output of the second sensor 22, at step S50, the acquisition unit 33a calculates the time difference ts between the first time t1 and the second time t2.

Through the above described step S1, the acquisition unit 33a acquires the time difference ts as the output corresponding to the movement speed s.

After step S1, at step S2, the determination unit 33b determines a content used for alert and timing TM of display of the content as the image G based on the output corresponding to the movement speed s. Step S2 includes step S60 to step S80.

After step S50, at step S60, the determination unit 33b determines whether the second time t2 is before the first time t1. When the second time t2 is before the first time t1, the above described step S10 is executed.

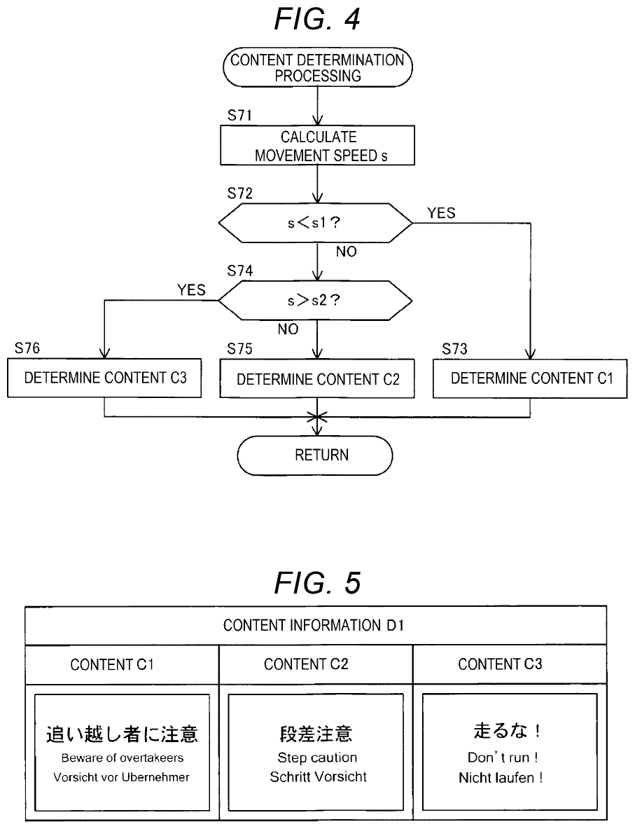

When the second time t2 is after the first time t1, at step S70, the determination unit 33b determines the content used for display based on the time difference ts. The details of the determination processing will be explained later with reference to FIGS. 4 and 5.

After step S70, at step S80, the determination unit 33b determines the timing TM of display of the content based on the time difference ts. Here, the determination unit 33b determines the timing TM to be earlier as the time difference ts is shorter. The determination is performed using e.g., information of a preset arithmetic expression or conversion table.

Through the above described step S2, the determination unit 33b determines the content used for the image G and the timing TM of display of the image G.

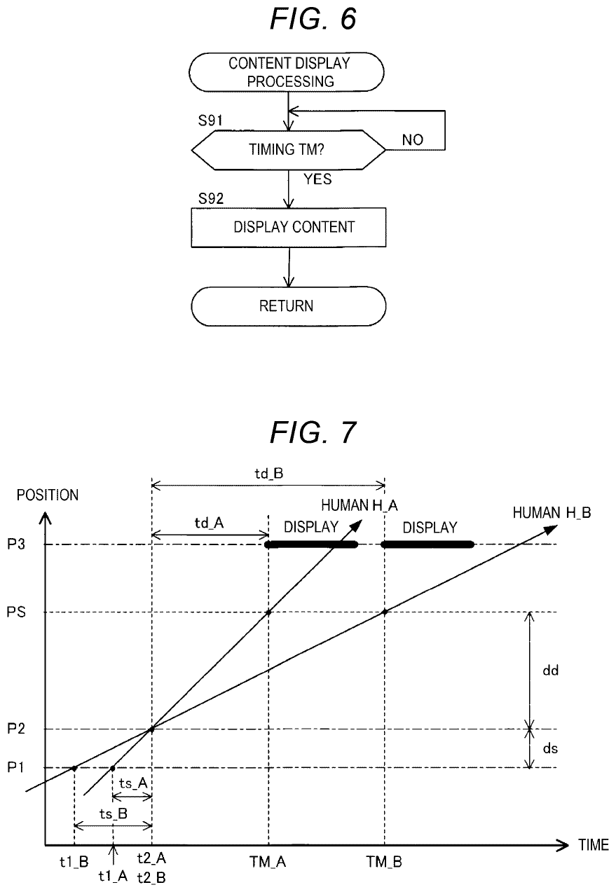

After step S80, at step S90, the display control unit 33c displays the content determined at step S70 as the image at the timing TM determined at step S80 in the third position P3 using the display apparatus 10. The details of the display processing will be explained later with reference to FIG. 6.

After step S90, at step S100, the processing device 33 determines whether there is an end instruction. When there is no end instruction, the processing device 33 goes to the above described step S10 and, on the other hand, when there is an end instruction, ends the processing.

FIG. 4 is a flowchart of determination of the content in the display method according to the first embodiment. At the above described step S70 in FIG. 3, as shown in FIG. 4, first, at step S71, the determination unit 33b calculates the movement speed s of the human H from the first position P1 to the second position P2.

Then, at step S72, the determination unit 33b determines whether the movement speed s is lower than a speed s1. The speed s1 is a lower speed than the average walking speed of a human, e.g., 1.0 m/sec or less.

When the movement speed s is lower than the speed s1, at step S73, the determination unit 33b determines a content C1 as the content of the image G. The content C1 is e.g., display for alerting the human H to a potential of presence of a human to overtake from behind. A specific example of the content C1 will be explained with reference to FIG. 5.

On the other hand, when the movement speed s is equal to or higher than the speed s1, at step S74, the determination unit 33b determines whether the movement speed s is equal to or higher than a speed s2. The speed s2 is a speed higher than the average walking speed of a human, e.g., 1.5 m/sec or more. Therefore, the speed equal to or higher than the speed s1 and lower than the speed s2 corresponds to a speed at which many walkers safely walk.

When the movement speed s is equal to or higher than the speed s1 and lower than the speed s2, at step S75, the determination unit 33b determines a content C2 as the content of the image G. The content C2 is e.g., display for alerting a level difference due to the slope SL. A specific example of the content C2 will be explained with reference to FIG. 5.

When the the movement speed s is equal to or higher than the speed s2, at step S76, the determination unit 33b determines a content C3 as the content of the image G. The content C3 is e.g., display for warning not to run. A specific example of the content C3 will be explained with reference to FIG. 5.

As described above, the determination unit 33b selects one of the contents C1 to C3 as the content of the image G based on the movement speed s. Here, the movement speed s is a physical quantity corresponding to the time difference ts, and it may also be stated that the determination unit 33b selects one of the contents C1 to C3 as the content of the image G based on the time difference ts. Therefore, regarding the contents C1, C2, when the time difference ts is equal to or smaller than a predetermined value corresponding to the speed s1, the content C2 is selected as an example of “first content” and, on the other hand, when the time difference ts is larger than the predetermined value corresponding to the speed s1, the content C1 is selected as an example of “second content”. Similarly, regarding the contents C2, C3, when the time difference ts is equal to or smaller than a predetermined value corresponding to the speed s2, the content C3 is selected as an example of “first content” and, on the other hand, when the time difference ts is larger than the predetermined value corresponding to the speed s2, the content C2 is selected as an example of “second content”.

FIG. 5 is a diagram for explanation of the contents C1, C2, C3 used for display. In FIG. 5, the specific examples of the contents C1, C2, C3 represented by the image information contained in the content information D1 are shown.

As shown in FIG. 5, the content C1 is for display for alerting the human H to a potential of presence of a human to overtake from behind. The content C2 is for display for alerting a level difference due to the slope SL. The content C3 is for display for warning not to run.

As described above, the display is changed in response to the movement speed s of the human H, and thereby, effective alert to the motion thought to be the most dangerous with respect to each section of the movement speed s may be displayed. In the example shown in FIG. 5, the respective contents C1, C2, C3 are displayed in multiple languages. Accordingly, effective alert may be displayed to people in multiple linguistic areas. Note that the contents C1, C2, C3 are not limited to the examples shown in FIG. 5, but arbitrary. Each of the contents C1, C2, C3 may be a plurality of contents including a plurality of types of contents sequentially switched or moving images.

FIG. 6 is a flowchart of display of a content in the display method according to the first embodiment. At the above described step S90 in FIG. 3, as shown in FIG. 6, first, at step S91, the display control unit 33c determines whether the timing TM at which the image G is to be displayed is reached. The timing TM is timing determined by the above described determination unit 33b.

When the timing TM at which the image G is to be displayed is reached, at step S92, the display control unit 33c controls the display apparatus 10 to display the content determined by the above described determination unit 33 as the image G.

FIG. 7 is a diagram for explanation of an example of display timing by the display method according to the first embodiment. In FIG. 7, the horizontal axis indicates the time and the vertical axis indicates the position, and respective relationships between the positions and the times of a human H_A and a human H_B are shown. Here, the respective human H_A and human H_B are humans H moving toward the third position P3 from the first position P1 via the second position P2. The movement speed s of the human H_A is higher than the movement speed s of the human H_B. Note that, in FIG. 7, “_A” is added to the signs of the elements corresponding to the human H_A and “B” is added to the signs of the elements corresponding to the human H_B.

The human H_A passes through the first position P1 at a first time t1_A and passes through the second position P2 at a second time t2_A. In this case, timing TM_A of start of display of the image G is timing corresponding to a time difference is A between the first time t1_A and the second time t2_A. With the timing TM_A, the human H_A is located in the position PS. The position PS is a position where the human H can effectively visually recognize the image G in the third position P3.

Here, regarding the timing TM_A, when the distance between the first position P1 and the second position P2 is ds, the distance between the second position P2 and the third position P3 is dd, the time difference from the second time t2_A to the timing TM_A is td_A, the time difference td_A is obtained from the relationship td_A=(dd/ds)ts_A. Therefore, the timing TM_A is defined by the time difference td_A as the timing of the human H_A located in the position PS.

As described above, when the time difference from the second time t2 to the timing TM is td, the timing TM is obtained from the relationship td=(dd/ds)ts.

On the other hand, the human H_B passes through the first position P1 at a first time t1_B and passes through the second position P2 at a second time t2_B. In this case, timing TM_B of start of display of the image G is timing corresponding to a time difference is B between the first time t1_B and the second time t2_B. With the timing TM_B, the human H_B is located in the position PS. In the example shown in FIG. 7, the second time t2_B coincides with the second time t2_A.

Here, a time difference td_B is obtained from a relationship td_B=(dd/ds)ts_B. Therefore, the timing TM_B is defined by the time difference td_B as the timing of the human H_B located in the position PS. The time difference td_B is longer than the time difference td_A. Accordingly, the timing TM_B is later than the timing TM_A.

As described above, the display method according to the first embodiment includes step S1, step S2, and step S90. Step S1 acquires the output corresponding to the movement speed s of the human H from the first position P1 to the second position P2 using the sensor 20. Step S2 determines the image G according to the content used for alert and the timing of display of the image G based on the output corresponding to the movement speed s. Step S90 displays the image G in the third position P3 with the timing using the display apparatus 10. The second position P2 is located between the first position P1 and the third position P3.

In the above described display method, the respective content used for alert and display timing thereof are determined based on the output corresponding to the movement speed s of the human H toward the display position, and thereby, the image G may be displayed with the appropriate timing or content to the human H.

Further, the display timing of the image G is determined in response to the movement speed s of the human H, and thereby, the image G may be displayed with the appropriate timing to the human H regardless of the placement position of the sensor 20.

In the embodiment, as described above, the sensor 20 includes the first sensor 21 outputting the first signal indicating detection of the passing of the human H in the first position P1 and the second sensor 22 outputting the second signal indicating detection of the passing of the human H in the second position P2. Step S1 includes step S10, step S30, and step S50. Step 10 acquires the first signal of the first sensor 21. Step S30 acquires the second signal of the second sensor 22. Step S50 calculates the time difference is between the first time t1 when the first signal of the first sensor 21 is acquired and the second time t2 when the second signal of the second sensor 22 is acquired.

When the distance ds between the first position P1 and the second position P2 is fixed, the time difference ts changes in response to the movement speed s of the human H from the first position P1 to the second position P2. That is, the movement speed s and the time difference ts have an inversely proportional relationship. Accordingly, the respective content used for alert and display timing thereof may be appropriately determined using the time difference ts. Further, compared to a case using an imaging device as the sensor 20, the configuration of the sensor 20 is simpler and image processing for obtaining the output corresponding to the movement speed s is unnecessary, and there is an advantage that the acquisition of the output corresponding to the movement speed s is quick and accurate and the configuration of the control apparatus 30 is simple. Here, it is preferable that the second sensor 22 is placed between the first sensor 21 and the display apparatus 10.

Further, as described above, step S90 includes step S60. Step S60 determines that the image G is not displayed when the first time t1 is before the second time t2. Accordingly, display of the image G to a human going in the opposite direction to the human H to be alerted is prevented. As a result, unnecessary display of the image G is reduced.

Furthermore, as described above, when the time difference ts from the first time t1 to the second time t2 is equal to or smaller than a predetermined value, step S90 determines use of the first content as the content. On the other hand, when the time difference ts from the first time t1 to the second time t2 is larger than the predetermined value, step S90 determines use of the second content different from the first content as the content.

As described above, the content is determined based on the time difference ts, and thereby, the appropriate content may be displayed as the image G corresponding to the movement speed s. Note that, in the embodiment, step S90 determines the content based on which of s<s1, s≥s2, and s1≤s<s2 the movement speed s of the human H satisfies. Here, as described above, the movement speed s of the human H and the time difference ts have the inversely proportional relationship, and the determination of the content based on the time difference ts includes the determination of the content based on the movement speed s.

As described above, step S2 includes step S80. Step S80 determines the timing TM as “third time” when the image G is displayed based on the time difference ts from the first time t1 to the second time t2. Accordingly, the image G may be displayed with the appropriate timing corresponding to the movement speed s of the human H.

The above described display method is performed using the display system 1. As described above, the display system 1 includes the display apparatus 10, the sensor 20 outputting in response to the movement speed s of the human H from the first position P1 to the second position P2, and the control apparatus 30 controlling the operation of the display apparatus 10 based on the output corresponding to the movement speed s from the sensor 20. Further, the control apparatus 30 executes the above described step S1, step S2, and step S90.

### 2. Second Embodiment

As below, a second embodiment will be explained. The configurations in common with the first embodiment have the same signs as those of the configurations and the explanation thereof is omitted. As below, the explanation will be made with a focus on the items different from those of the above described first embodiment and the explanation of the same items will be omitted.

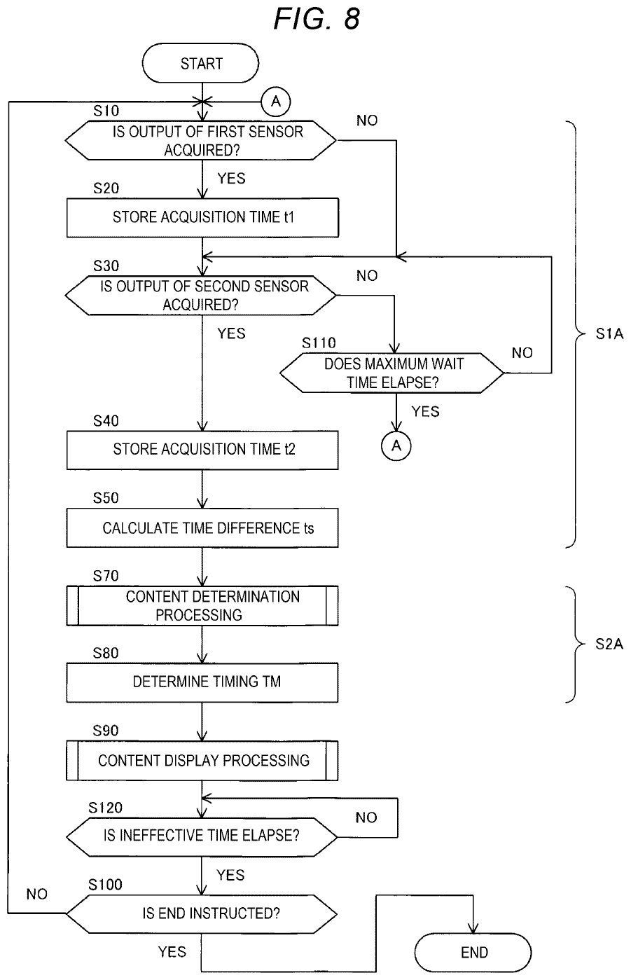

FIG. 8 is a flowchart of display of a content in a display method according to the second embodiment. The display method of the second embodiment is the same as the above described display method of the first embodiment except that step S1A and step S2A are provided in place of the above described step S1 and step S2 in FIG. 3. Here, step S1A is the same as step S1 of the first embodiment except that step S110 is added. step S2A is the same as step S2 of the first embodiment except that the above described step S60 shown in FIG. 3 is omitted and step S120 is added.

In the embodiment, as shown in FIG. 8, when not acquiring the output of the second sensor 22, the acquisition unit 33a determines whether the maximum wait time over a predetermined time Tth elapses at step S110.

When the maximum wait time does not elapse, the acquisition unit 33a returns to step S30. Accordingly, the acquisition unit 33a tries to acquire the output of the second sensor 22 until the maximum wait time elapses.

On the other hand, when the maximum wait time elapses, the acquisition unit 33a returns to step S10. Accordingly, when the maximum wait time elapses, and then, the acquisition unit 33a acquires the output of the first sensor 21, the first time t1 stored in the memory device 32 is updated. That is, in this case, the information on the first time t1 within the memory device 32 is discarded.

Further, in the embodiment, after step S90, at step S120, the display control unit 33c determines whether an ineffective time over a predetermined time TI elapses. Here, step S120 is repeated until the ineffective time elapses. Accordingly, over a period until the ineffective time elapses, the acquisition unit 33a does not acquire at least the low-level signal output by the first sensor 21. Specifically, the signal may not be acquired by disconnection between the acquisition unit 33a and the first sensor 21. Or, the first sensor 21 may be controlled not to output the signal. When the ineffective time elapses, the display control unit 33c goes to step S100. Then, when the acquisition unit 33a acquires the output of the first sensor 21, the information on the first time t1 within the memory device 32 is discarded by updating. Further, when the acquisition unit 33a acquires the output of the second sensor 22, the information on the second time t2 within the memory device 32 is discarded.

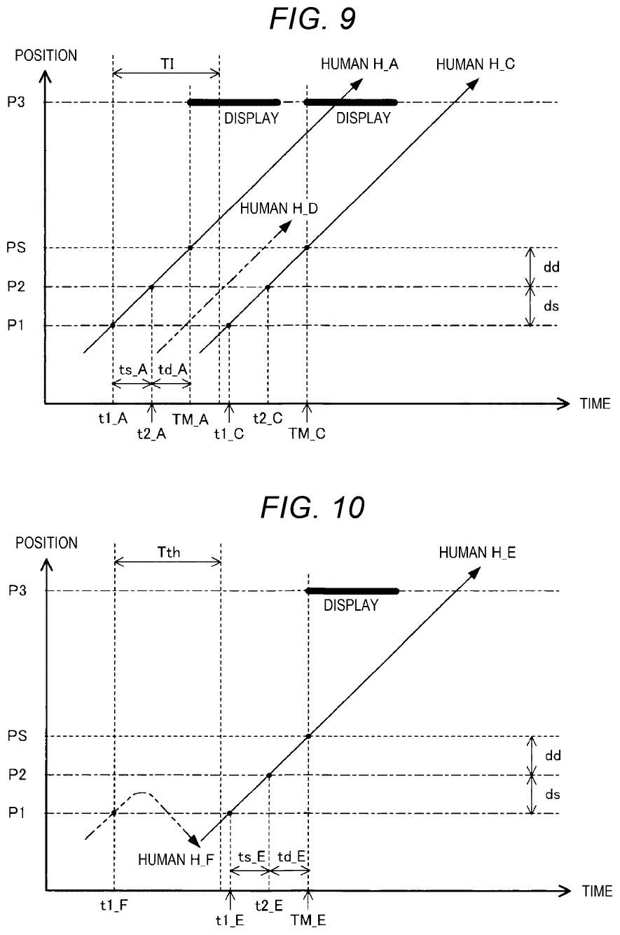

FIG. 9 is a diagram for explanation of an example of display timing by the display method according to the second embodiment. In FIG. 9, the horizontal axis indicates the time and the vertical axis indicates the position, and respective relationships among the positions and the times of a human H_A, a human H_C, and a human H_D are shown. Here, the respective human H_A, human H_C, and human H_D are humans H moving toward the third position P3 from the first position P1 via the second position P2. The timing of passing through the first position P1 is in the order of the human H_A, the human H_D, and the human H_C. Note that, in FIG. 9, “_A” is added to the signs of the elements corresponding to the human H_A and “_C” is added to the signs of the elements corresponding to the human H_C.

Like the above described FIG. 7, the human H_A passes through the first position P1 at the first time t1_A and passes through the second position P2 at the second time t2_A. In this case, timing TM_A of start of display of the image G is timing corresponding to a time difference ts_A between the first time t1_A and the second time t2_A. With the timing TM_A, the human H_A is located in the position PS.

The human H_C passes through the first position P1 at a first time t1_C and passes through the second position P2 at a second time t2_C. Here, the first time t1_C is after the predetermined time TI elapses from the first time t1_A. In this case, the image G is displayed with timing TM_C. With the timing TM_C, the human H_C is located in the position PS. Further, the timing TM_C is after a display period of the image G elapses due to the human H_A sequentially passing through the first position P1 and the second position P2.

On the other hand, the human H_D passes through the first position P1 before the predetermined time TI elapses from the first time t1_A. In this case, even when the human H_D sequentially passes through the first position P1 and the second position P2, the acquisition unit 33a does not acquire the signal output by the first sensor 21, and thereby, the image G due to the passing is not displayed. As a result, switching of the image G is prevented in the middle of the display period of the image G due to the human H_A sequentially passing through the first position P1 and the second position P2. Therefore, display of the image G to the human H_A is performed over a desired period. Further, the display of the image G to the human H_A can also be visually recognized by the human H_D. Accordingly, the human H_D may also be alerted by the display of the image G.

FIG. 10 is a diagram for explanation of another example of display timing by the display method according to the second embodiment. In FIG. 10, the horizontal axis indicates the time and the vertical axis indicates the position, and respective relationships between the positions and the times of a human H_E and a human H_F are shown. Here, the human H_E is a human H moving toward the third position P3 from the first position P1 via the second position P2. On the other hand, the human H_F is a human H passing through the first position P1, then, moving in the opposite direction, and passing through the first position P1 again. Note that, in FIG. 10, “_E” is added to the signs of the elements corresponding to the human H_E and “_F” is added to the signs of the elements corresponding to the human H_F.

The human H_E passes through the first position P1 at a first time t1_E and passes through the second position P2 at a second time t2_E. In this case, timing TM_E of start of display of the image G is timing corresponding to a time difference ts_E between the first time t1_E and the second time t2_E. With the timing TM_E, the human H_E is located in the position PS.

Here, the human H_F passes through the first position P1 at a first time t1_F before the first time t1_E. A time difference between the first time t1_E and the first time t1_F is longer than the predetermined time Tth. As described above, during the period of the predetermined time Tth, the output of the first sensor 21 is not newly acquired. Accordingly, even when the human H_F passes through the first position P1, then, moves in the opposite direction, and passes through the first position P1 again, the passing is not detected. As a result, unnecessary display of the image G due to the human H_F is prevented. Further, display of the image G based on false detection due to an insect or some flying object may be prevented. Furthermore, as described above, acquisition and update of the output of the first sensor 21 can be performed after a lapse of the period of the predetermined time Tth, and, as described above, display of the image G to the human H_E is appropriately performed.

Also, according to the above described second embodiment, the image G may be displayed with the appropriate timing or content to the human H. The display method according to the embodiment includes step S120 as described above. When determining the image G, Step S120 stops acquisition of the output of the first sensor 21 over the period until the predetermined time TI elapses from the first time t1. Accordingly, unintended switching between contents is prevented. As a result, a desired content may be appropriately displayed over a necessary period.

Further, as described above, when the second signal is not output from the second sensor 22 in the period until the predetermined time TI elapses from the first time t1, step S1A discards the information on the first time t1. Accordingly, system down by a processing loop based on inappropriate information may be prevented.

### 3. Third Embodiment

As below, a third embodiment will be explained. The configurations in common with the first embodiment have the same signs as those of the configurations and the explanation thereof is omitted. As below, the explanation will be made with a focus on the items different from those of the above described first embodiment and the explanation of the same items will be omitted.

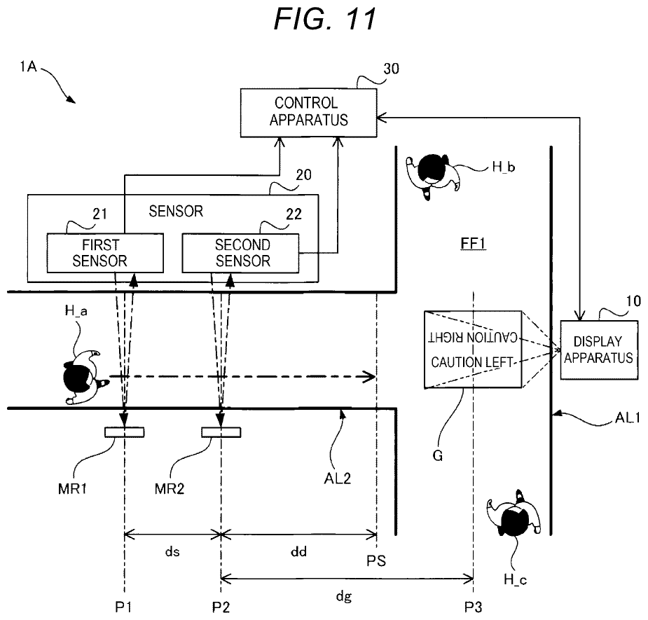

FIG. 11 is a schematic diagram of a display system 1A according to the third embodiment. The display system 1A has the same configuration as the above described display system 1 of the first embodiment except that the installation location is different and the display content and the display orientation of the image G are different.

In the example shown in FIG. 11, an aisle AL1 and an aisle AL2 form a T-junction, and the display system LA alerts a human H_b or a human H_c coming down the aisle AL1 using the image G. Here, the T-junction is formed with an end of the aisle AL2 coupled to the midway of the aisle AL1, and the third position P3 is located at the junction of the aisle AL1 and the aisle AL2. Further, the respective first position P1 and second position P2 are positions in the length direction of the aisle AL2 and located before the junction. The first position P1, the second position P2, and the third position P3 are sequentially arranged in a direction toward the junction.

Note that the forms of the aisles AL1, AL2 including widths or shapes are not limited to the examples shown in FIG. 11, but arbitrary. Further, the third position P3 is not limited to the example shown in FIG. 11, but may be, e.g., a position on a screen provided in the aisle AL1 or a position on a left or right wall surface or a ceiling surface of the aisle AL1.

In the embodiment, when a human H_a coming down the aisle AL2 sequentially passes through the first position P1 and the second position P2, the image G is displayed in the third position P3. Thereby, the human H_b or the human H_c coming down the aisle AL1 may be alerted by the image G.

Here, the image G has display to the respective human H_b and human H_c. In the example shown in FIG. 11, the image G has display of “CAUTION RIGHT” to the human H_b and display of “CAUTION LEFT” to the human H_c. Further, the display of “CAUTION RIGHT” to the human H_b is set in an orientation easily viewable for the human H_b and the display of “CAUTION LEFT” to the human H_c is set in an orientation easily viewable for the human H_c.

Also, according to the above described third embodiment, the image G may be displayed with the appropriate timing or content to the human H. As described above, in the embodiment, the display of the image G includes determination of the orientation of the display of the image G in a direction different from the direction from the first position P1 toward the second position P2. Accordingly, the appropriate image G may be displayed at the junction of aisles such as a T-junction. As a result, an event such as a collision accident between humans at the junction may be preferably prevented.

### 4. Fourth Embodiment

As below, a fourth embodiment will be explained. The configurations in common with the first embodiment have the same signs as those of the configurations and the explanation thereof is omitted. As below, the explanation will be made with a focus on the items different from those of the above described first embodiment and the explanation of the same items will be omitted.

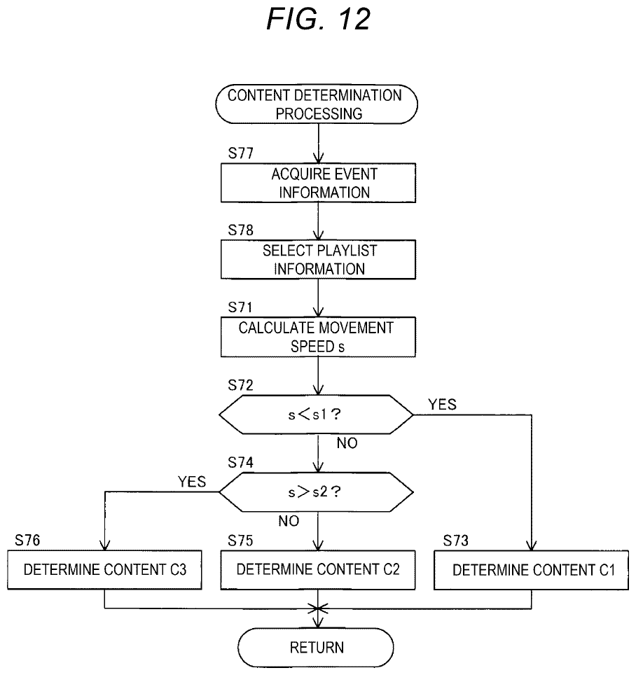

FIG. 12 is a flowchart of determination of a content in a display method according to the fourth embodiment. The embodiment is the same as the first embodiment except that the determination processing of the content is different. The determination processing of the content of the embodiment is the same as the above described determination processing of the content shown in FIG. 4 except that step S77 and step S78 are added.

Though not shown in the drawing, in the embodiment, a plurality of pieces of playlist information D2 having different contents C1, C2, C3 with respect to each date, time, or day of week are stored in the memory device 12.

As shown in FIG. 12, in the content determination processing of the embodiment, first, at step S77, the determination unit 33b acquires event information. The event information is information on a date, a time, or a day of week. The event information is acquired using e.g., a clock function of the display system 1 or the like.

Then, at step S78, the determination unit 33b selects one piece of playlist information D2 of the plurality of pieces of playlist information D2 based on the event information. Then, like the first embodiment, the determination unit 33b goes to step S71.

Also, according to the above described fourth embodiment, the image G may be displayed with the appropriate timing or content to the human H. As described above, the display method of the embodiment includes determination of the content of the image G based on the date, the time, or the day of week. Accordingly, the content of the image G corresponding to the date, the time, or the day of week may be displayed. Further, reduction in effect of alert due to habituation like in a case where the same display is continued may be avoided. Note that the event information is not particularly limited, but may be e.g., information on predetermined date and time of a festival or the like, information regularly or randomly changing like a time or a random number, or information changing in real time according to traffic information or weather.

### 5. Modified Examples

The respective embodiments exemplified as above may be modified in various forms. Specific modifications that may be applied to the above described respective embodiments will be exemplified as below. Two or more forms arbitrarily selected from the following exemplifications may be appropriately combined to be mutually consistent.

### 5-1. Modified Example 1

In the above described respective embodiments, the configuration in which the sensor 20 has the first sensor 21 and the second sensor 22 is exemplified, however, not limited to the configuration. The sensor 20 may have e.g., an imaging device such as a CCD (Charge Coupled Device) image sensor or a CMOS (Complementary MOS) image sensor as long as the sensor outputs in response to the movement speed s of the human H from the first position P1 to the second position P2. In this case, for example, the imaging device images a region including the first position P1 and the second position P2, the human H moving from the first position P1 to the second position P2 is detected by image processing on the captured image by the imaging device, and the detection result is output from the sensor 20.

### 5-2. Modified Example 2

In the above described respective embodiments, the configuration in which the display apparatus is the projection device is exemplified, however, not limited to the configuration. The display apparatus may be an apparatus having a liquid crystal display panel, an organic EL (electro-luminescence) panel, or the like as a display surface.

What is claimed is:

1. A display method comprising:
acquiring output corresponding to a movement speed of a human from a first position to a second position using at least one sensor;
determining an image according to a content used for alert based on the output corresponding to the movement speed;
determining a time to display the image based on the output corresponding to the movement speed; and
displaying the image at the time in a third position using a display apparatus, wherein
the second position is located between the first position and the third position.

2. The display method according to claim 1, wherein
the at least one sensor includes
a first sensor outputting a first signal indicating detection of passing of the human through the first position, and
a second sensor outputting a second signal indicating detection of passing of the human through the second position, and
the acquiring output corresponding to the movement speed includes
acquiring the first signal of the first sensor,
acquiring the second signal of the second sensor, and
calculating a time difference between a first time when acquiring the first signal and a second time when acquiring the second signal.

3. The display method according to claim 2, wherein
the second sensor is placed between the first sensor and the display apparatus.

4. The display method according to claim 2, wherein
the determining the image includes not displaying the image when the second time is before the first time.

5. The display method according to claim 2, wherein
the determining the image includes
determining use of a first content as the content when the time difference from the first time to the second time is equal to or smaller than a predetermined value, and
determining use of a second content different from the first content as the content when the time difference is larger than the predetermined value.

6. The display method according to claim 2, wherein
the determining the image includes determining a third time when displaying the image based on the time difference from the first time to the second time.

7. The display method according to claim 2, further comprising, when determining the image, stopping acquisition of the output of the first sensor in a predetermined period from the first time.

8. The display method according to claim 2, wherein
the acquiring the output corresponding to the movement speed includes discarding information on the first time when the second signal is not output by the second sensor in a predetermined period from the first time.

9. The display method according to claim 2, wherein
the displaying the image includes determining an orientation of the image to be displayed in a direction different from a direction from the first position to the second position.

10. The display method according to claim 2, wherein
the determining the image includes determining the content based on a date, a time, or a day of week.

11. A display system comprising:
a display apparatus;
a sensor; and
a control apparatus controlling operation of the display apparatus, the control apparatus executing
acquiring output corresponding to a movement speed of a human from a first position to a second position from the sensor,
determining an image according to a content used for alert based on the output corresponding to the movement speed,
determining a time to display the image based on the output corresponding to the movement speed, and
displaying the image at the time in a third position using the display apparatus, and
the second position is located between the first position and the third position.
